(19) United States
(12) Patent Application Publication
(10) Pub. No.: US 2006/0279014 A1
(43) Pub. Date: Dec. 14, 2006

(54) Making foamed bodies

(76) Inventors: Ian Henry Balchin, Oxfordshire (GB); John Feast, Oxfordshire (GB)

Correspondence Address: LAW OFFICES OF WILLIAM H. HOLT, 12311 HARBOR DRIVE, WOODBRIDGE, VA, 22192, US

(21) Appl. No.: 10/552,612

(22) PCT Filed: May 19, 2004
(86) PCT No.: PCT/GB04/02178

§ 371 Date: Oct. 6, 2005

(30) Foreign Application Priority Data
May 20, 2003 (GB) 0311494.9

(51) Int. Cl. B29C 44/58

(52) U.S. Cl. 264/51; 264/491; 425/4 R; 425/174.2; 249/134

(57) ABSTRACT

Making foamed bodies by introducing a biodegradable polymer mixture into a mould (10) in which it is heated to form a foam and to fill the mould. The mould is defined between two opposed parts (12, 14) that mate together, and each mould part is of electrically conducting material, and the moulding surfaces are coated with an electrically insulating material (16). Radio-frequency signals are applied (25) between the mould parts (12, 14) so that the polymer mixture is heated by dielectric heating, so a foam tray is formed in less than 15 s. This provides a more rapid cycle time than using heated moulds. The radio frequency signals may be 27.12 MHz, or 40.68 MHz. The polymer may be starch-based.

The present invention relates to a method and an apparatus for making foamed bodies, particularly but not exclusively those made with a biodegradable or water-soluble polymeric material.

In recent years considerable research has gone into the development of biologically degradable polymers, for example those based on starch. For example U.S. Pat. No. 5,705,536 (Tomka) mentions that a starch foam can be produced by mixing powdered starch with water, and extruding the mixture while converting the water to steam. Tomka indicates that it would be advantageous to use thermoplastic starch, or polymer blends containing thermoplastic starch, in producing such foamed bodies; such starch contains typically less than 1% by weight of water, and Tomka teaches mixing it with a fibrous material such as ramie fibres containing moisture. The mixture can be converted into a foam by extrusion at about 200° C. The properties of the resulting product may be modified by adding, for example, plasticising agents and lubricants to the mixture. As explained in U.S. Pat. No. 6,235,815B (Loercks et al) thermoplastic starch can be made from essentially anhydrous starch that is homogenised in an extrusion process with the addition of a plasticiser such as glycerol or sorbitol, and is melted within a temperature range between 120° and 220° C.; thermoplastic starch may be combined with other biodegradable polymers such as polycaprolactone. Loercks et al teach that a polymer mixture can be made from anhydrous starch mixed directly with a hydrophobic polymer such as an aliphatic polyester, under dry conditions. And U.S. Pat. No. 6,494,704B (Andersen et al) describe a mould press for making articles such as bowls or trays, the articles being formed between male and female mould halves, and being made from a starch-based composition that also contains water and may also contain fibres and inorganic fillers, the moulds being heated to between 170° and 220° C. The moulds may be of a metal such as steel or brass, and may be provided with a nonstick coating of PTFE. Some of the resulting water vapour is allowed to escape through a vent, while some causes foaming expansion of the material in the mould. After a time that is preferably in the range between 30 seconds and 2 minutes the mould halves can be separated, and the foamed bodies removed. It will be appreciated that a more rapid heating cycle would be beneficial.

According to the present invention there is provided a method of making a biodegradable foamed body, in which a polymer mixture comprising a biodegradable polymer and water is introduced into a mould, the mould being defined between moulding surfaces of two opposed parts that mate together, wherein each mould part is of electrically conducting material and each of the moulding surfaces is coated with a layer of electrically insulating material, and wherein radio-frequency signals are applied between the mould parts so that the polymer mixture is heated by dielectric heating, such that the water turns to steam, so the polymer mixture forms a foam, fills the mould and sets in no more than 15 s.

The radio frequency supply may in principle be at a frequency between 1 MHz and 200 MHz, usually between 10 MHz and 100 MHz, but stringent limits are imposed on any emitted radio waves. In practice therefore the choice of frequency may be more limited. For example the supply frequency may be 27.12 MHz, or 40.68 MHz. This provides a much more rapid way of heating the polymer mixture, so that the heating, foaming and setting requires no more than 15 seconds, and preferably between 5 and 10 seconds.

The present invention also provides an apparatus for making a foamed body from a polymer mixture, the apparatus including a mould defined between moulding surfaces of two opposed parts that mate together, wherein each mould part is of electrically conducting material and each of the moulding surfaces is coated with a layer of an electrically insulating material, and means to apply radio-frequency signals between the mould parts so that polymer mixture between the mould parts is heated by dielectric heating.

The electrically insulating material used to coat the moulding surfaces is preferably one that is not dielectrically heated, for example PFA (perfluoro alkoxyalkane). Silicone rubber is also suitable, providing good thermal and electrical installation. A surface coating of PTFE is also beneficial, as this makes removal of the body, once it has set, easier. The layer of electrically insulating material is preferably no more than 2 mm thick.

The polymer mixture contains water, which forms steam on heating; no other foaming agents are used. The polymer mixture is preferably a starch-based polymer, and may include thermoplastic starch. For good foaming it is important that the pressure becomes high in the die as the steam is generated, so the steam must not be freely vented.

The invention will now be further and more particularly described, by way of example only, and with reference to the accompanying drawings in which:

FIG. 1 shows a cross-sectional view through the upper and lower halves of a mould, when separated;

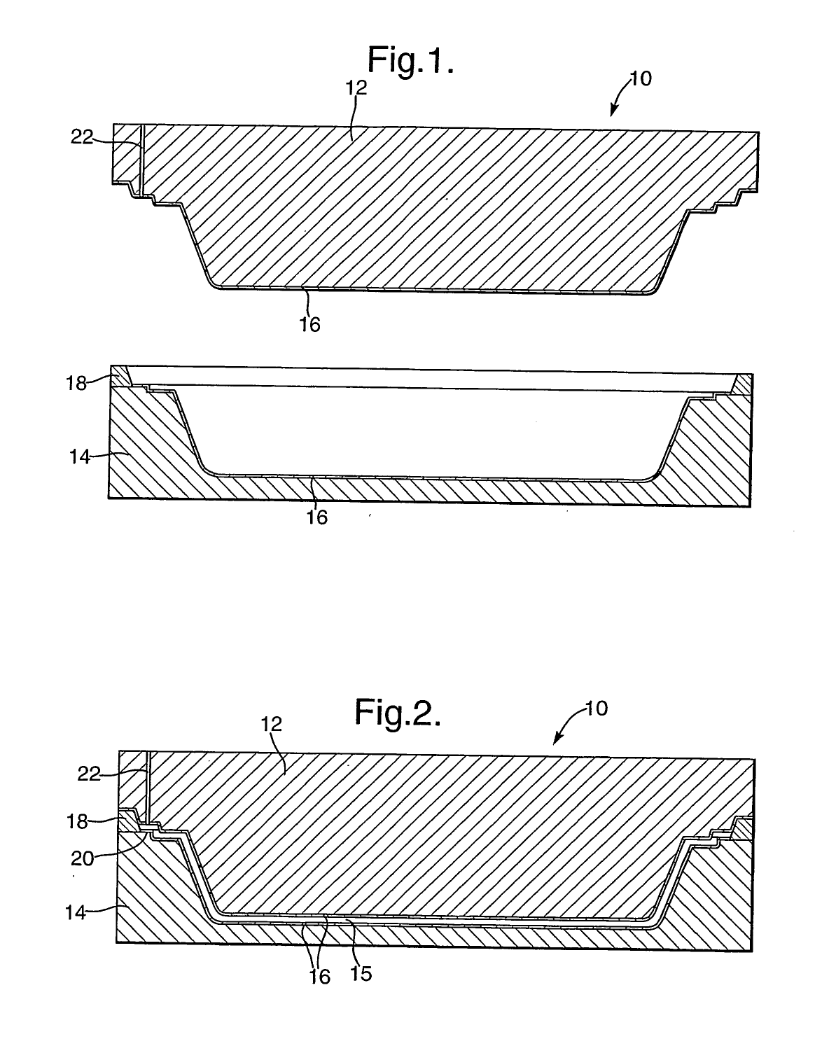

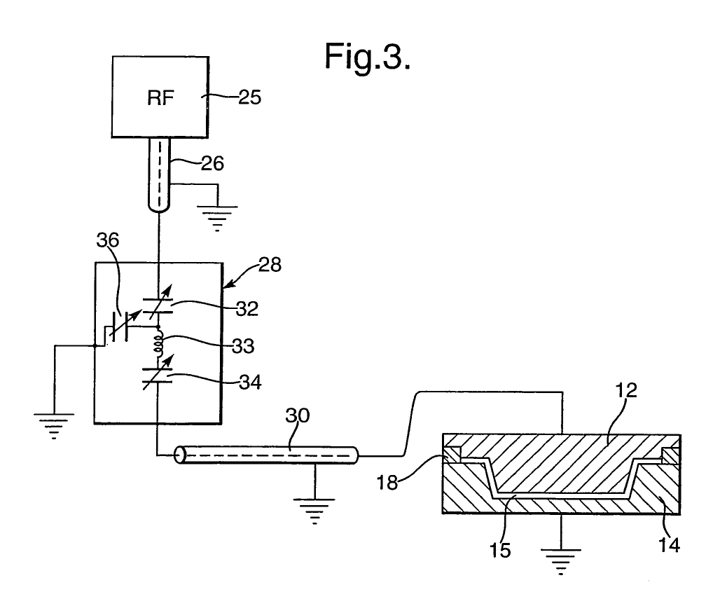

FIG. 2 shows a view corresponding to that of FIG. 1 during manufacture of a foamed body within the mould; and

FIG. 3 shows a diagrammatic view of the electrical circuit of the apparatus that includes the mould.

Referring to FIGS. 1 and 2, an apparatus 10 for making trays of a foamed starch-based polymeric material includes upper and lower mould halves, 12 and 14 respectively, which mate together to leave a narrow cavity 15 between them in which the tray is to be formed. Each mould half 12 and 14 is of brass, and each has a coating 16 of PFA electrical insulator over the entire surface facing the cavity 15. With the two halves 12 and 14 separated as shown in FIG. 1, polymeric material is introduced into the lower half 14, and the upper half 12 is then lowered into position. A peripheral ridge 18 of electrically-insulating alumina on the lower half 14 has a sloping inner face, and contacts a correspondingly-shaped peripheral rim on the upper half 12 such that the cavity 15 is of uniform thickness 2.5 mm and the halves 12 and 14 of the mould are held accurately aligned. Radio frequency signals are then applied between the two halves 12 and 14, which act as electrodes. The alumina ridge 18 ensures that the radio-frequency signals are concentrated across the cavity 15. The polymeric material becomes hot, and water in the polymeric mixture boils, so that the material becomes a foam filling the entire cavity 15.

Immediately adjacent to the peripheral ridge 18, the upper mould half 12 defines a peripheral recess 20 which communicates through a narrow slot with the mould cavity 15. There are several narrow ducts 22 (only one of which is shown) extending through the upper mould half 12 from this peripheral recess 20. Steam from the hot polymeric mixture can escape into the peripheral recess 20, and hence escape through the narrow ducts 22, but the ducts 22 restrict the flow of the steam, so the pressure in the cavity 15 rapidly rises as the polymer foams up. For example it may rise to above 10 atmospheres. This corresponds to the steam and polymer mixture reaching a temperature above about 185° C. After about 8 seconds the polymeric mixture has formed a self-supporting tray, and the two halves are again separated, and the tray removed.

It will be appreciated that such an apparatus may be used to make a wide range of different products, by using appropriately-shaped moulds, and that the products may be of any desired shape. For example it may be used to make multi-compartment trays, circular or square plates or bowls, or cups, or a clam-shell container formed of two shells hinged together along a straight edge. It will also be appreciated that, although the apparatus has been shown as comprising only a single mould, there might instead be several moulds forming an array, all the moulds being connected to a common radio frequency supply.

Referring now to FIG. 3, the electrical circuit is shown diagrammatically. A radio-frequency signal generator 25, which is a solid-state device, supplies the radio frequency signal via a coaxial cable 26 to a matching network 28, from which the signal is supplied via a coaxial cable 30 to the upper mould half 12, the lower mould half 14 being earthed. The matching network 28 is shown in more detail. The signal passes through a variable capacitor 32, an inductor 33, and a variable capacitor 34, and so to the cable 30. A monitoring circuit (not shown) monitors the radio frequency current and voltage, and adjusts the values of the variable capacitors 32 and 34 so that the impedance presented to the generator 25 remains at a constant value such as 50 ohms. The junction between the capacitor 32 and the inductor 34 is connected through a capacitor 36 to earth potential, and the effective capacitance of this capacitor 36 can be adjusted. This has the effect of finely adjusting the radio frequency voltage applied between the live electrode (the upper mould half 12) and the opposed, earthed electrode (the lower mould half 14), and the RF current supplied. It thus controls the power that is actually supplied between the mould halves 12 and 14.

The nature of the polymer is not critical to the present invention, although the polymer must be biodegradable, and is preferably at least partly starch-based. The polymer may include thermoplastic starch, but because this may not contain significant quantities of water it is necessary to include another ingredient that provides the requisite water in order to form the foam. A benefit of using thermoplastic starch is that the resulting foamed body, although biodegradable, does not readily dissolve in water. Alternatively the polymer may comprise starch granules at least partly gelatinised by reacting with water. The mixture may contain salt (e.g. NaCl), to alter its electrical conductivity, and may also contain a plasticiser such as sorbitol. The polymeric mixture may contain other polymeric materials, and may also contain reinforcing fibres, such as cellulose organic fibres such as those from hemp or cotton or other plants. Although the fibres strengthen the resulting foamed products, the concentration of fibres preferably does not exceed about 50%, and is preferably no more than 25% of the total weight. It will also be appreciated that the polymeric mixture may be introduced into the mould in the form of a film, granules, pellets, a preform or a pasty mixture, and may be of a wet appearance.

For example, foamed starch trays have been made by mixing cornstarch (cornflour) and water in equal quantities by mass. This mixture was then introduced into a mould as described above, but with the cavity 15 being of thickness 2 mm and of diameter 110 mm. When radio-frequency energy was applied, the starch mixture foamed up to produce a foam tray filling the cavity. The volume increase is greater than three times.

It will be appreciated that the apparatus may be modified in various ways, for example the thickness of the coating 16 of electrical insulator may be between 20 and 50 μm. And as mentioned above, the mould shape will depend upon the shape of the desired product. When making a product that includes a hinge (such as a clam-shell container), the hinge may be provided by a strip of a polymeric non-foaming material (for example a strip of hydroxypropylmethylcellulose) placed in the mould along with the mixture of which forms the foam, so that the hinge strip becomes integral with the foam parts on each side of the hinge.

1. A method of making a biodegradable foamed body, in which a polymer mixture comprising a biodegradable polymer and water is introduced into a mould, the mould being defined between moulding surfaces of two opposed parts that mate together, wherein the polymer mixture contains no foaming agents apart from water, each mould part is of electrically conducting material and each of the moulding surfaces is coated with a layer of an electrically insulating material, and wherein radio-frequency signals at a frequency between 1 MHZ and 200 MHZ are applied between the mould parts so that the polymer mixture is heated by dielectric heating, such that the water turns to steam, causing the polymer mixture to form a foam, fill the mould and set in no more than 15 s, the mould restricting the flow of steam such that the pressure in the mould rises to above 10 atmospheres during the foaming process.

2. A method as claimed in claim 1 wherein the radio-frequency signals are applied such that the polymer mixture forms a foam, fills the mould and sets in less than 10 s.

3. A method as claimed in claim 1 wherein the radio-frequency signals are applied at a frequency between 20 MHZ and 50 MHZ.

4. A method as claimed in claim 3 wherein the polymer mixture is at least in part starch-based.

5. (canceled)

6. An apparatus for making a foamed body from a polymer mixture that contains no foaming agents apart from water, the apparatus including a mould defined between moulding surfaces of two opposed pats that mate together, wherein each mould part is of electrically conducting material and is coated with a layer of an electrically insulating material, and means to apply radio-frequency signals between the mould parts so that polymer mixture between the mould parts is heated by dielectric heating, the mould being such as to restrict the flow of steam such that the pressure in the mould rises to above 10 atmospheres during the foaming process.

7. An apparatus as claimed in claim 6 wherein the electrically insulating material used to coat the moulding surfaces is one that is not dielectrically heated.

8. An apparatus as claimed in claim 6 wherein, when the mould parts are together, they are held apart by an electrical insulator that is thicker than the gap defining the mould.
